(19) United States
(12) Patent Application Publication
(10) Pub. No.: US 2015/0321934 A1
(43) Pub. Date: Nov. 12, 2015

(54) WATER PRODUCTION METHOD

(71) Applicant: TORAY INDUSTRIES, INC., TOKYO (JP)

(72) Inventors: Kentaro Kobayashi, Otsu-shi, Shiga (JP); Hiroo Takabatake, Otsu-shi, Shiga (JP)

(73) Assignee: TORAY INDUSTRIES, INC., TOKYO (JP)

(21) Appl. No.: 14/424,159

(22) PCT Filed: Aug. 30, 2013
(86) PCT No.: PCT/JP2013/073318

§ 371 Date: Feb. 26, 2015

(30) Foreign Application Priority Data
Aug. 30, 2012 (JP) 2012-189636

(51) Int. Cl. C02F 9/00; C02F 1/66; B01D 65/06; B01D 61/14; C02F 1/44; C02F 1/52

(52) U.S. Cl. CPC C02F 9/00; C02F 1/444; C02F 1/52; B01D 65/06; B01D 61/145; C02F 1/66; B01D 61/147; B01D 2321/04; B01D 2321/185; B01D 2321/12; C02F 2303/14

(57) ABSTRACT

Provided is a process for producing water including generating a water to be filtrated wherein a water to be treated is treated to generate a water to be filtrated; filtration wherein the water to be filtrated is filtrated through a separation membrane module having a separation membrane to generate a filtrated water; back washing wherein the substance to be removed by filtration which has blocked the separation membrane in the step of filtration is washed away by using a cleaning water; and drainage wherein cleaning drainage generated in the step of back washing is drained; wherein the step of generating the water to be filtrated has a coagulation substep of adding a first pH adjuster and a cationic coagulant to coagulate the substance to be removed by filtration in the water to be treated to thereby generate the pretreated water; the water to be filtrated used in the step of filtration satisfies the following expression (i); and the step of back washing has at least first back washing substep wherein the separation membrane is back-washed by the cleaning water satisfying the following expressions (ii) and (iii):

4.0≦pH of the water to be filtrated≦6.5 (i)

pH of the cleaning water≦9.0 (ii)

pH of the cleaning water−pH of the water to be filtrated≧1.0 (iii).

### CROSS REFERENCE TO RELATED APPLICATIONS

This is the U.S. National Phase application of PCT International Application No. PCT/JP2013/073318, filed Aug. 30, 2013, and claims priority to Japanese Patent Application No. 2012-189636, filed Aug. 30, 2012, the disclosures of each of these applications being incorporated herein by reference in their entireties for all purposes.

### FIELD OF THE INVENTION

This invention relates to a process for producing water wherein a water to be treated is filtrated through a separation membrane to produce a filtrated water, and more specifically, this invention relates to a process for producing water having the step of back washing the separation membrane wherein suspended substances and coagulation flocks are efficiently discharged.

### BACKGROUND OF THE INVENTION

Separation membranes such as microfiltration membrane (MF membrane) and ultrafiltration membrane (UF membrane) having reduced pore diameter are recently introduced since they are capable of removing the components that had been difficult to remove by the conventional water treatment process. Removal of viruses and low-molecular weight organic substance solely by the separation membrane, however, is still difficult even by the water treatment process using such separation membrane, and the countermeasure has been incorporation of a coagulation process in the upstream of the use of membrane so that the viruses and low-molecular weight organic substance will be incorporated in the coagulation flocks and the removal rate of the viruses and low-molecular weight organic substance will be improved in the subsequent treatment using the membrane. In the coagulation process, the viruses and low-molecular weight organic substance which are generally present in water in mutually repelling state due to their negative charge are incorporated in the coagulation flocks by coagulation through neutralization of the charge and weakening of the repellent force by applying positively charged cationic coagulant. However, the viruses and low-molecular weight organic substance have small particle diameter, and hence, relatively large surface area, and a large amount of coagulant is required for the neutralization of the negative charge, and this resulted in the problem of increased cost required for the treatment such as coagulation and sludge treatment.

Patent Documents 1 and 2 propose decrease of the pH during the coagulation as a countermeasure for such problem in view of the feature of the coagulants that the positive charge per unit coagulant increases with decrease in the pH. These documents argue that the positive charge can be increased by the decrease of the pH without increasing the amount of the coagulant.

In addition, in the water treatment process using a separation membrane, the membrane filtration can be continued only for limited time since transmembrane pressure difference increases with the blocking of the separation membrane by the substance to be removed by filtration. More specifically, in the separation membrane module, the suspended substances and the coagulation flocks in the water to be treated clog the surface and pores of the separation membrane or deposits in the interior of the separation membrane module after the filtration for considerable period, for example, in the space between the separation membranes to adversely affect the filtrating performance. In view of such situation, the step of regularly cleaning the separation membrane is incorporated in the water treatment process. The step generally employed for cleaning the separation membrane is the so called “step of back washing” wherein the back wash of separation membrane module is conducted from the secondary side (the side to which the filtrated water is supplied) to the primary side (the side from which the water to be filtrated is supplied) by using the filtrated water to remove the suspended substances and the coagulation flocks that had deposited on the surface and in the pores of the separation membrane and between the separation membranes and discharge them to the exterior of the separation membrane module. As a method for improving the cleaning ability in such step, Patent Documents 3 and 4 disclose increase in the pH of the back wash cleaning water in the back washing of the separation membrane module from the secondary side to the primary side. These documents indicate that increase in the pH of the back wash cleaning water to the pH level of 10 or higher enables efficient decomposition and removal of the substance blocking the membrane and prevention of the increase of the pressure difference.

### PATENT DOCUMENTS

### Patent Document 1: Japanese Unexamined Patent Publication (Kokai) No. 2009-125708

Patent Document 2: Japanese Unexamined Patent Publication (Kokai) No. H11-239789

### Patent Document 3: Japanese Unexamined Patent Publication (Kokai) No. 2005-224671

### Patent Document 4: Japanese Unexamined Patent Publication (Kokai) No. 2011-125822

### SUMMARY OF THE INVENTION

When the techniques disclosed by Patent Documents 1 and 2 are applied for the purpose of suppressing the increase in the amount of the coagulant, safe operation may become difficult by the rapid increase in the transmembrane pressure difference. In the meanwhile, the back wash conducted by using the high pH cleaning water disclosed in Patent Documents 3 and 4 may invite problems such as increase in the cost of chemicals required for the back wash and requirement of a large amount of water for neutralizing the membrane.

In addition, when the neutralization of the cleaning solution remaining in the separation membrane module and/or the cleaning drainage is insufficient, pH in the interior of the separation membrane module will be increased and this will invite release from the coagulation flocks of the component to be removed that had been incorporated in the coagulation flocks by the coagulation in the low pH range. This results in the problem of reduced removal performance.

In view of the problems as described above, an object of the present invention is to provide a water production process by the separation membrane wherein loss of the performance of removing the components to be removed and increase in the pressure difference during the filtration can be suppressed; and wherein the amount of chemicals and water used in the cleaning of the separation membrane can be reduced.

The present invention which intends to solve the problems as described above includes the following constitution.

(1) A process for producing water comprising:

a step of generating a water to be filtrated wherein a water to be treated is treated to generate a water to be filtrated;

a step of filtration wherein the water to be filtrated is filtrated through a separation membrane module having a separation membrane to generate a filtrated water;

a step of back washing wherein the substance to be removed by filtration which has blocked the separation membrane in the step of filtration is washed away by using a cleaning water; and a step of drainage wherein cleaning drainage generated in the step of back washing is drained; wherein

the step of generating the water to be filtrated has a coagulation substep of adding a first pH adjuster and a cationic coagulant to coagulate the substance to be removed by filtration in the water to be treated to thereby generate the pretreated water;

the water to be filtrated used in the step of filtration satisfies the following expression (i); and

the step of back washing has at least first back washing substep wherein the separation membrane is back-washed by the cleaning water satisfying the following expressions (ii) and (iii):

4.0≦pH of the water to be filtrated≦6.5 (i)

pH of the cleaning water≦9.0 (ii)

pH of the cleaning water−pH of the water to be filtrated≧1.0 (iii).

(2) The process for producing water according to the above (1) wherein, in the first back washing substep of the step of back washing, a second pH adjuster is added to the filtrated water to prepare the cleaning water satisfying the expressions (ii) and (iii).
(3) The process for producing water according to the above (1) or (2) wherein second back washing substep wherein further back wash is conducted by using the filtrated water is conducted after the first back washing substep of the step of back washing.
(4) The process for producing water according to any one of the above (1) to (3) wherein, in the first back washing substep of the step of back washing, air scrubbing by introducing a gas on the primary side of the separation membrane module is simultaneously conducted.
(5) The process for producing water according to any one of the above (1) to (4) wherein, in the second back washing substep of the step of back washing, air scrubbing by introducing a gas on the primary side of the separation membrane module is simultaneously conducted.
(6) The process for producing water according to any one of the above (1) to (5) wherein the step of generating the water to be filtrated has a solid-liquid separation substep for obtaining a separated liquid after the coagulation substep.
(7) The process for producing water according to the above (6) wherein the pH adjuster is introduced in the separated liquid, and the pH is adjusted in each step and/or substep to satisfy the following expression (iv) to (vi):

pH of the pretreated water≦pH of the water to be filtrated≦pH of the cleaning water (iv)

pH of the water to be filtrated−pH of the pretreated water≧1.0 (v)

pH of the water to be filtrated≦7.5 (vi)

The present invention enables stable water production by the separation membrane by suppressing the loss of the performance of removing the components to be removed and increase in the pressure difference during the filtration. The present invention also enables reduction in the amount of chemicals and water used in the cleaning of the separation membrane.

### BRIEF DESCRIPTION OF THE DRAWINGS

FIG. 1 This figure is a flow chart schematically showing an embodiment of the cleaning process of the separation membrane in the water production process of the present invention.

FIG. 2 This figure is a flow chart schematically showing another embodiment of the cleaning process of the separation membrane in the water production process of the present invention.

FIG. 3 This figure is a flow chart schematically showing further embodiment of the cleaning process of the separation membrane in the water production process of the present invention.

FIG. 4 This figure is a flow chart schematically showing further embodiment of the cleaning process of the separation membrane in the water production process of the present invention.

FIG. 5 This figure is a flow chart schematically showing further embodiment of the cleaning process of the separation membrane in the water production process of the present invention.

FIG. 6 This figure is a flow chart schematically showing further embodiment of the cleaning process of the separation membrane in the water production process of the present invention.

FIG. 7 This figure is a graph showing varying of the transmembrane pressure difference of the separation membrane.

### DETAILED DESCRIPTION OF EMBODIMENTS OF THE INVENTION

The water production process of the present invention includes a process for producing water comprising the steps of generating a water to be filtrated wherein a water to be treated is treated to generate a water to be filtrated; the step of filtration wherein the water to be filtrated is filtrated through a separation membrane module having a separation membrane to generate a filtrated water; the step of back washing wherein the substance to be removed by filtration which has blocked the separation membrane in the step of filtration is washed away by using a cleaning water; and the step of drainage wherein cleaning drainage generated in the step of back washing is drained. The step of generating the water to be filtrated has a coagulation substep of adding a first pH adjuster and a cationic coagulant to coagulate the substance to be removed by filtration in the water to be treated to thereby generate the pretreated water; the water to be filtrated used in the step of filtration satisfies the following expression (i); and the step of back washing has at least first back washing substep wherein the separation membrane is back-washed by the cleaning water satisfying the following expressions (ii) and (iii).

4.0≦pH of the water to be filtrated≦6.5 (i)

pH of the cleaning water≦9.0 (ii)

pH of the cleaning water−pH of the water to be filtrated≧1.0 (iii).

In the present invention, the water production process includes the process of producing the filtrated water from the water to be treated by the steps as described above. Use of the steps as described above enables continuous production of the filtrated water having the substance to be removed by filtration removed therefrom. The term “continuous production” as used herein means that the operation of water production as a whole can be continuously conducted by sequentially conducing at least the step of filtration, the step of back washing, and the step of drainage. More specifically, adequate inclusion of the step of back washing and the like enables continuous operation in view of the entire system without stopping the operation at each blocking of the filtration membrane by coagulation flocks and the like. It is to be noted that the step of generating the water to be filtrated may be repeatedly conducted by incorporating this step in the integral cycle with the step of filtration, the step of back washing, and the step of drainage; or alternatively, the step of generating the water to be filtrated may be conducted in a batch process as a step outside such cycle by conducting the process as a preliminary step or a step in different production line.

In the water production process of the present invention, the water to be treated may be water such as river water, lake water, underground water, sea water, brine, sewage, treated sewage, industrial waste water, or the like. The water production process of the present invention can be used for the water containing organic substance or chromatic component dissolved therein or virus whose removal had been difficult by the conventional water production method using a separation membrane. The water production process of the present invention may also be applied for the water to be treated containing the organic substance from algae, humic acid, surfactant, and the like which are generally conceived to inhibit the coagulation.

In the water production process of an embodiment of the present invention, the coagulation substep in the step of generating the water to be filtrated is the substep wherein the substance to be removed by filtration in the water to be treated is coagulated, and the water to be treated which has undergone the coagulation substep is called “the pretreated water”. In this coagulation substep, a first pH adjuster and a cationic coagulant are added to the water to be treated to thereby obtain the pretreated water. The water to be filtrated supplied to the step of filtration satisfies the expression (i). The step of generating the water to be filtrated includes at least the coagulation substep, and further inclusion of the solid-liquid separation substep as described below is also preferable. When the step of generating the water to be filtrated solely comprises the coagulation substep, the pretreated water generated in the coagulation substep is used in the step of filtration as the water to be filtrated, and when the step of generating the water to be filtrated also includes the solid-liquid separation substep after the coagulation substep, the resulting separated liquid (or the separated liquid having the pH adjuster added thereto) is used in the step of filtration as the water to be filtrated. The substance to be removed by filtration which has been coagulated (a mixture of the substance to be removed by filtration and the coagulant) is called “coagulation flocks”. Such pretreatment increases positive charge of the cationic coagulant, and hence, capacity of neutralizing the charge, and this in turn results in the increase in the efficiency of incorporating the substance to be removed by filtration to the coagulation flocks, and hence, improvement in the efficiency of removing the substance to be removed by filtration in the subsequent step of filtration.

In the water production process of an embodiment of the present invention, the step of filtration is the step wherein the water to be filtrated is filtrated through the separation membrane module having the separation membrane to generate the filtrated water having at least some of the substance to be removed by filtration and the coagulation flocks containing the substance to be removed by filtration in the water to be filtrated removed therefrom. The separation membrane used in this step is preferably a microfiltration membrane (MF membrane) having a pore size of 0.1 to 1 μm suitable for the separation of the coagulation flocks or an ultrafiltration membrane (UF membrane) having a pore size of 0.01 to 0.1 μm. Excessively high pressure will be required when the separation membrane is a nanofiltration membrane or a reverse osmosis membrane having smaller pore diameter, and stable operation may become difficult due to the likeliness of the separation membrane being blocked by the coagulation flocks.

In the water production process of an embodiment of the present invention, the step of back washing is the step wherein the substance to be removed by filtration that has blocked the separation membrane in the step of filtration is washed away. Since this step includes a first back washing substep wherein the cleaning water used in the back washing of the separation membrane satisfies at least the expressions (ii) and (iii), the performance of removing the coagulation flocks attached and/or blocking the separation membrane can be improved, and as a consequence, increase in the pressure difference can be suppressed, and at the same time, decrease of the removal rate of the substance to be removed by filtration in the coagulation substep of the step of generating the water to be filtrated can be prevented. It is to be noted that the “attached and/or blocking the separation membrane” may be simply referred to as “attached to the separation membrane”.

In the water production process of an embodiment of the present invention, the step of drainage is the step wherein the cleaning drainage generated in the back washing is discharged. The “cleaning drainage” is the cleaning water containing the suspending substances and coagulation flocks that had been attached on the separation membrane generated in the step of back washing. “The suspending substances and the coagulation flocks” may be hereinafter abbreviated as “coagulation flocks and the like”. The discharge of the cleaning drainage enables discharge of the coagulation flocks and the like in the cleaning drainage to the exterior of the separation membrane module and prevention of the decrease of the removal rate in the initial phase of the subsequent step of filtration of the substance to be removed by filtration that had been coagulated in the step of generating the water to be filtrated.

The cleaning water satisfying the expressions (ii) and (iii) used in the first back washing substep is preferably the one prepared by adding a second pH adjuster to the filtrated water in view of the simple constitution of the apparatus.

In addition, incorporation of a second back washing substep wherein the back wash is conducted by using the filtrated water for the cleaning water after the first back washing substep is preferable. In the following description, the cleaning water used in the first back washing substep is referred to as the “first cleaning water” and the cleaning water used in the second back washing substep is referred to as the “second cleaning water” when distinction between the cleaning waters used in the respective back washing substeps is necessary. The incorporation of the second back washing substep is preferable since, when the second back washing substep is incorporated, the increase in the pH of the water to be filtrated by the mixing with the first cleaning water can be suppressed in the initial phase of the step of filtration and further decrease of the removal rate of the substance to be removed by filtration is thereby prevented.

Preferably, air scrubbing wherein a gas is introduced in the primary side of the separation membrane module is simultaneously conducted in the first back washing substep and/or the second back washing substep of the step of back washing in view of efficiently removing the coagulation flocks from the separation membrane.

In addition, the step of generating the water to be filtrated preferably has the step of obtaining a separated liquid by solid-liquid separation after the coagulation substep. The separated liquid is the residual water generated by the removal of the coagulation flocks which are coagulants containing the substance to be removed by filtration from the pretreated water. By conducting the solid-liquid separation before the step of filtration, sludge load on the separation membrane module can be reduced, and stability of the step of filtration will then be improved. In such case, operation of the separation membrane module can be further stabilized when the pH in each step and/or substep is adjusted to satisfy the expressions (iv) to (vi) simultaneously with the introduction of the pH adjuster in the separated liquid.

In the water production process of an embodiment of the present invention, the cycle including at least the step of filtration, the step of back washing containing the first back washing substep, and step of drainage is repeated to suppress the loss of the performance of removing the component to be removed in the filtration and increase of the pressure difference to thereby enable stable water production by the separation membrane and also reduce the chemicals and cleaning water used in the washing of the separation membrane. This system, however, may also be operated so that, of the two or more cycles of the step of back washing, the first back washing substep is conducted in one cycle and the back washing using the filtrated water not having the second pH adjuster added thereto is conducted in other cycles. In this case, amount of the chemicals used in the cleaning can be reduced although the effect of suppressing the increase of the pressure difference will not be as significant.

Next, each step is further described in detail mainly in chemical point of view.

In the coagulation substep of the step of generating the water to be filtrated, a first pH adjuster and a cationic coagulant are added to the water to be treated to generate the pretreated water. The thus obtained water to be filtrated satisfying the following expression (i) is used in the step of filtration. The first pH adjuster is preferably an acid or an alkali. Exemplary preferable acids include inorganic acids such as sulfuric acid and hydrochloric acid. The acid, however, is not limited and organic acids such as citric acid and oxalic acid may also be used. Preferable non-limiting examples of the alkali include inorganic alkali such as caustic soda or potassium hydroxide.

4.0≦pH of the water to be filtrated≦6.5 (i)

Coagulation performance of the cationic coagulant can be improved by adjusting the pH of the first pH adjuster to the range of the expression (i).

Of the cationic coagulants (hereinafter also simply referred to as coagulants), in the case of inorganic coagulants, positive charge of the coagulant increases with the decrease in the pH, and this results in the increase in the capability of neutralizing the negative charge. In the case of polyaluminum chloride (PAC), for example, peak of the positive charge is at pH 4.5 while the peak pH may vary by the water quality, and dissolution starts with the decrease in the pH, and this results in the decrease of the positive charge. Accordingly, the ability of neutralizing the negative charge reaches its maximum in the weakly acidic pH range. As a consequence, incorporation of the components having small particle size or low molecular weight (substance to be removed by filtration) which are hardly coagulated by applying the coagulant alone into the coagulation flocks is enabled in the weakly acidic to neutral pH range. More specifically, the water to be filtrated (pretreated water) is adjusted to the pH range of at least 4.0 and up to 6.5, and more preferably to the pH range of at least 4.5 and up to 6.0 since the effect of incorporating the substance to be removed by filtration into the coagulation flock is further improved.

Preferably, the pH of the water to be filtrated (pretreated water) is preliminarily adjusted to an optimal pH since the effect of incorporating the substance to be removed by filtration into the coagulation flocks in the step of generating the water to be filtrated differs by the nature of the water to be treated and the type of the component to be removed (substance to be removed by filtration). The optimal pH adjustment method is not particularly limited, and exemplary methods include pH adjustment based on the evaluation by jar tester of the effect of incorporating the target component to be removed (substance to be removed by filtration) in the coagulation flocks at each pH, and pH adjustment depending on the concentration of particular component in the water to be treated.

In such step of generating the water to be filtrated, the cationic coagulant forms the coagulation flocks by adsorption and crosslinking of the component to be removed with the coagulant. By forming the coagulation flocks as described above, the components having small particle size or low molecular weight (substance to be removed by filtration) which are hardly coagulated by applying the coagulant alone into the coagulation flocks can also be removed by the separation membrane in the subsequent step.

Exemplary cationic coagulants used include inorganic coagulants and high-molecular weight coagulants, and the preferred are inorganic coagulants since pH can be reduced and the positive charge can be more effectively increased. The preferred are aluminum- and iron-based inorganic coagulants such as PAC, aluminum sulfate, ferric chloride, and polysilica iron.

In the step of back washing, the coagulation flocks and the like attached to the separation membrane can be more effectively washed away, and as a consequence, increase in the pressure difference can be suppressed and decrease of the removal rate of the substance to be removed by filtration that has been coagulated in the step of generating the water to be filtrated can be prevented when the step of back washing has at least the first back washing substep wherein the separation membrane is washed by the first cleaning water satisfying the following expressions (ii) and (iii):

pH of the cleaning water≦9.0 (ii)

pH of the cleaning water−pH of the water to be filtrated≧1.0 (iii).

The first cleaning water satisfying the following expressions (ii) and (iii) used in the first back washing substep may be prepared by adding the second pH adjuster to the filtrated water. The pH adjuster used is preferably an alkali such as caustic soda or potassium hydroxide. The pH adjuster, however, is not limited to these chemicals, and other exemplary chemicals include sodium bicarbonate and sodium hypochlorite.

In the present invention, it has been found that the ability to remove the coagulation flocks attached to the separation membrane can be improved, and hence, increase in the pressure difference can be improved by cleaning the separation membrane with the first cleaning water having a pH higher than that of the water to be filtrated. In addition, the intended effects of the present invention can be realized when the pH of the first cleaning water is adjusted to a pH level 1.0 or more higher than the pH of the water to be filtrated since the effects of the present invention are less-significant when the pH difference between the water to be filtrated and the first cleaning water is less than 1.0. In view of realizing the effects of the invention, pH is preferably adjusted to the level at least 2.0 higher than the pH of the water to be filtrated.

On the other hand, while more efficient cleaning is realized by the use of cleaning water with higher pH, an excessively high pH of the first cleaning water is likely to invite reduced removal rate of the component to be removed due to the mixing of the cleaning drainage generated from the first cleaning water remaining in the separation membrane module after the cleaning of the separation membrane with the water to be filtrated which results in the increase in the pH of the water to be filtrated. Accordingly, the pH of the first cleaning water is preferably adjusted to the level not exceeding 9.0 in the present invention to achieve sufficient cleaning effects simultaneously with the maintenance of the removal rate of the component to be removed. In such point of view, in the present invention, after the first back washing substep wherein the back washing of the separation membrane had been conducted by using the first cleaning water, the separation membrane is preferably cleaned by using a filtrated water having a pH not greatly (in theory) differing from that of the water to be filtrated.

When the back washing of the separation membrane is conducted in the first back washing substep by using a cleaning water having a pH higher than the water to be filtrated, the cleaning drainage will remain after the step of drainage on the primary side of the separation membrane module, and when the water to be filtrated is supplied in the initial phase of the subsequent step of filtration, pH of the water to be filtrated increases due to the remaining cleaning drainage, and the removal rate of the component to be removed may decrease. In view of such situation, a second back washing substep wherein the back washing of the separation membrane is conducted by using the filtrated water having a pH theoretically not much different from the water to be filtrated for the second cleaning water is conducted after the first back washing substep wherein the back washing of the separation membrane is conducted by using the first cleaning water. In the case of such constitution, pH on the primary side of the separation membrane module will be reduced to a pH level substantially the same as the water to be filtrated, and the increase in the pH of the water to be filtrated supplied to the initial phase of the subsequent filtrating will be suppressed to enable maintenance of the removal rate of the component to be removed (substance to be removed by filtration).

When the step of generating the water to be filtrated has the step of obtaining a separated liquid by solid-liquid separation after the coagulation substep, the pH adjuster is introduced in the separated liquid, and the pH in each step and/or substep is adjusted to satisfy the expressions (iv) to (vi), operation of the separation membrane module can be further stabilized since sludge load on the separation membrane module will be reduced.

In the coagulation substep of the step of generating the water to be filtrated, the coagulation flocks which coagulated at a low pH and which are not removed by the liquid-solid separating apparatus accumulates on the separation membrane module in the long term although such coagulation flocks are not much, and such coagulation flocks needs to be washed away by the first back washing substep of the step of back washing. However, a more stable operation of the separation membrane module is enabled when a third pH adjuster is introduced in the separated liquid to generate the separated liquid at a pH that is 1.0 or more higher than the pretreated water, and the membrane filtration is conducted in the separation membrane module since charge of the coagulation flocks with excessive positive charge becomes more neutral with the increase in the pH and attachment of the coagulation flocks to the separation membrane becomes weaker. When the difference between the pH of the water to be filtrated which is the separated liquid having the third pH adjuster introduced therein and the pH of the pretreated water is less than 1.0, the effect of removing the coagulation flocks from the separation membrane is insufficient, and therefore, the pH of the water to be filtrated which is the separated liquid having the third pH adjuster introduced therein is preferably adjusted to a pH level 1.0 or more higher than the pretreated water. In the meanwhile, when the pH of the water to be filtrated which is the separated liquid having the third pH adjuster introduced therein is increased, the component to be removed (substance to be removed by filtration) which had been incorporated in the coagulation flocks starts to be detached from the coagulation flocks and the removal rate of the component to be removed tends to be reduced. When the pH of the water to be filtrated (the separated liquid having the third pH adjuster added thereto) is increased to the level higher than 7.5, the probability of the detachment of the coagulation flocks from the membrane increases, and accordingly, the water to be filtrated which is the separated liquid having the third pH adjuster introduced therein is adjusted to a pH of up to 7.5 to thereby to enable the detachment rate of the component to be removed from the coagulation flocks. More specifically, the pH of the water to be filtrated (the separated liquid having the third pH adjuster added thereto) is adjusted to the level of up to 7.0 to further reduce the detachment rate of the component to be removed from the coagulation flocks and improve the removal rate of the component to be removed. In addition, when the back wash of the separation membrane is conducted by using a cleaning water having a pH higher than that of the separated liquid which is the water to be filtrated, the coagulation flocks attached to the separation membrane can be more efficiently detached, and as a consequence, increase in the pressure difference can be suppressed. Furthermore, the intended effects of the present invention can be realized when the pH of the cleaning water is adjusted to a pH level 1.0 or more higher than the pH of the water to be filtrated (the separated liquid having the third pH adjuster added thereto) since the effects of the present invention are less significant when the pH difference between the water to be filtrated (the separated liquid having the third pH adjuster added thereto) and the cleaning water is smaller. In view of realizing the effects of the invention, pH is preferably adjusted to the level at least 2.0 higher than the pH of the water to be filtrated.

Because of the reason as described above, the water to be filtrated prepared by introducing a third pH adjuster to the separated liquid preferably has a pH satisfying the following expressions (iv) to (vi):

pH of the pretreated water≦pH of the water to be filtrated≦pH of the cleaning water (iv)

pH of the water to be filtrated−pH of the water to be filtrated≧1.0 (v)

pH of the water to be filtrated≦7.5 (vi)

The third pH adjuster is preferably an alkali, and examples of such alkali include an inorganic alkali such as caustic soda, potassium hydroxide, and sodium hydrogencarbonate. The third pH adjuster is not limited to such chemicals, and other examples include chemicals with approximately neutral pH, oxidizing agents such as sodium hypochlorite, and chemicals such as anionic high-molecular weight coagulant.

Next, specific embodiments of the water production process of the present invention are described in detail by referring to the drawings, which by no means limit the scope of the present invention.

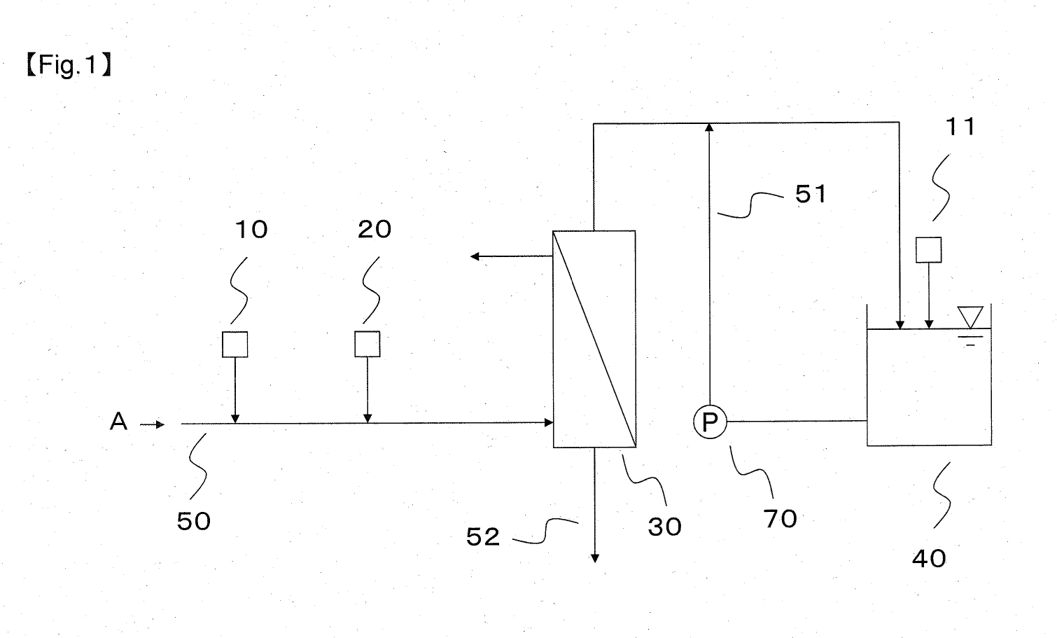

FIG. 1 is a flow chart showing an embodiment having the constitution of the water production process of the present invention. The coagulation substep of the step of generating the water to be filtrated of this embodiment uses an installation comprising a first pH adjustment apparatus 10 which introduces a first pH adjuster to a water supply line 50 provided for supplying the water to be treated to a separation membrane module 30 to thereby generate a first pH adjusted water and a cationic coagulant introducing apparatus 20 which introduces a cationic coagulant to the first pH adjusted water is employed to generate a pretreated water which is used as the water to be filtrated. The pretreated water satisfying the expression (i) as described above is thereby generated, and this pretreated water is supplied as the water to be filtrated. The method used for the formation of coagulation flocks in the cationic coagulant introducing apparatus 20 is not particularly limited, and the coagulation flocks may be formed by conducting high-speed agitation in a coagulant mixing tank provided therein or by conducing low-speed agitation in a coagulation flock-formation tank provide in the downstream of the mixing tank. Alternatively, the coagulation flocks may be formed by introducing the coagulant in the line and conducting the agitation by an inline mixer such as static mixer.

The step of filtration uses an installation constituted from a separation membrane module 30 which generates the filtrated water. In this installation, the pretreated water generated in the step of generating the water to be filtrated is used for the water to be filtrated and the filtrated water is generated by membrane filtration. The filtrated water is stored in a filtrated water tank 40. The installation constituted from the separation membrane module 30 preferably has at least 2 separation membrane modules 30 arranged in parallel.

The separation membrane used in the present invention is not particularly limited for its material, and separation membranes made from organic and inorganic materials can be used. Exemplary organic materials include polypropylene, polyacrylonitrile, ethylene-tetrafluoroethylene copolymer, polychlorotrifluoroethylene, polytetrafluoroethylene, polyvinyl fluoride, tetrafluoroethylene-hexafluoropropylene copolymer, chlorotrifluoroethylene-ethylene copolymer, polyvinylidene fluoride, polysulfone, polyethersulfone, and acetic acid cellulose, and exemplary inorganic materials include ceramics. The operation method of the present invention is particularly effective for the separation membrane whose surface is negatively charged in the pH range of 4.0 to 9.0.

In addition, the separation membrane is not particularly limited for the shape, and examples include hollow fiber, flat membrane, spiral, and tubular separation membranes. In addition, the separation membrane is preferably formed in the form of a separation membrane module, and the separation membrane module such as pressure or immersion-type separation membrane module may be adequately selected depending on the intended use. In view of drainage of the coagulation flocks to the exterior of the separation membrane module, use of an immersion-type separation membrane module is preferable.

In such separation membrane module 30, the water to be filtrated is generally filtrated at a constant flow rate or at a constant pressure.

The first back washing substep of the step of back washing uses an installation comprising the second pH adjustment apparatus 11 which introduces the second pH adjuster to the filtrated water stored in the filtrated water tank 40 to generate the cleaning water and the installation comprising the back wash pump 70 which sends the first cleaning water which has been prepared to satisfy the expressions (ii) and (iii) through the back wash cleaning water line 51, and these enable cleaning of the separation membrane by the back washing from the secondary side to the primary of the separation membrane module 30. In the step of drainage, the water used in the step of back washing is drained from the separation membrane module 30 through the water drainage line 52.

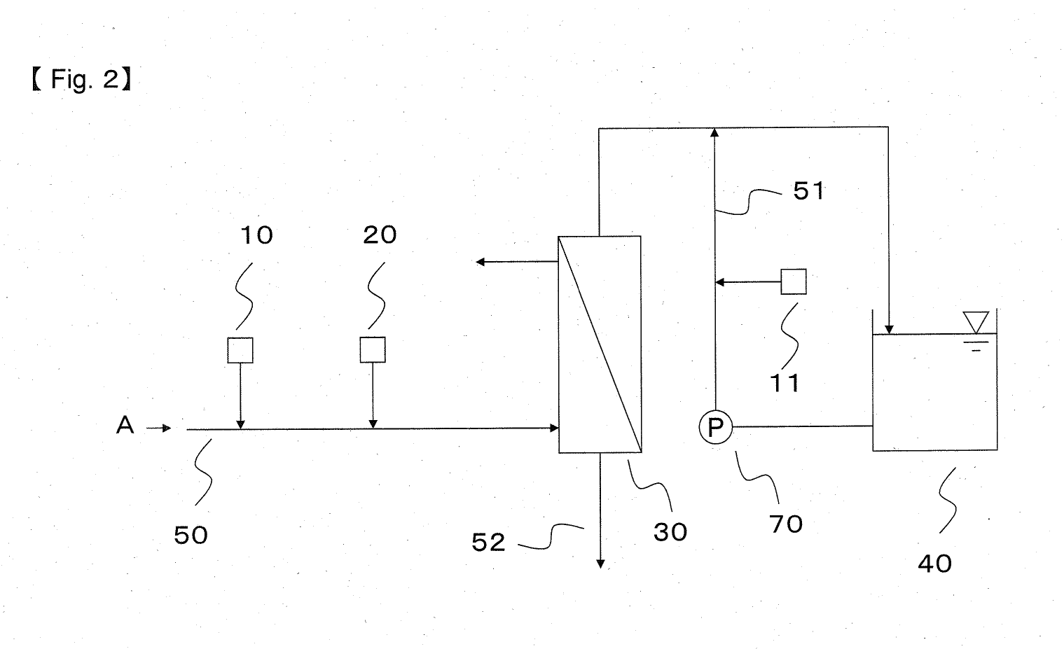

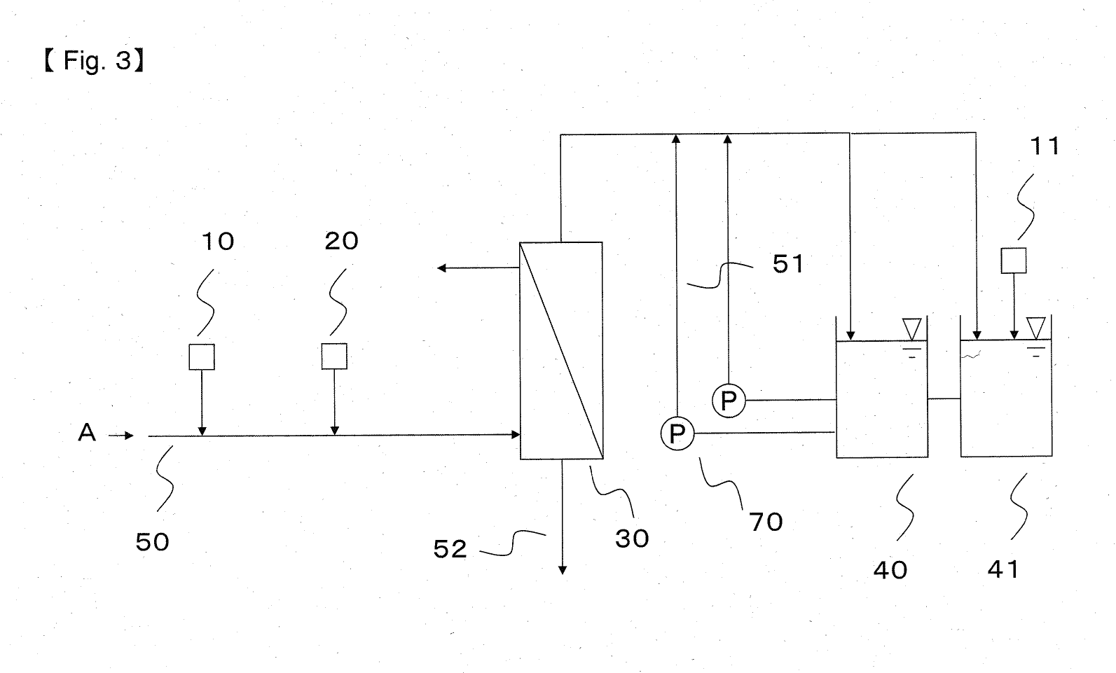

The embodiment of FIG. 1 is an embodiment wherein the step of back washing solely comprises the first back washing substep. However, a second back washing substep is preferably conducted after the first back washing substep, and in such second back washing, the separation membrane module 30 may be cleaned by using a filtrated water having a pH theoretically not so much different from the water to be filtrated (namely, the water with no addition of the second pH adjuster) for the second cleaning water. In such case, the installation for second back wash is not particularly limited for its constitution, and as shown in FIG. 2, a second pH adjustment apparatus 11 wherein the second pH adjuster is added to filtrated water may be provided in the back wash cleaning water line 51, and a second agitator (not shown) for addition of the second pH adjuster and agitation may be provided in the downstream to enable switching between the first back washing substep and the second back washing substep by the on/off of the second pH adjustment apparatus 11. Alternatively, as shown in the constitution of FIG. 3, a pH adjustment tank 41 may be provided in addition to the filtrated water tank 40, and the second pH adjustment apparatus 11 for introducing the second pH adjuster may be provided in the pH adjustment tank 41. In the case of such constitution, the pH-adjusted first cleaning water may be supplied from the pH adjustment tank 41 for the back wash of the separation membrane module 30, and then, the filtrated water may be supplied from filtrated water tank 40 as the second cleaning water for the back wash of the separation membrane module 30.

It is also preferable that, after the back washing of the separation membrane module 30 with the first cleaning water, the water on the primary side of the separation membrane module is drained to the exterior of the separation membrane module, and then, back washing of the separation membrane module 30 is conducted with the second cleaning water. Such drainage of the water on the primary side enables further suppression of the pH increase.

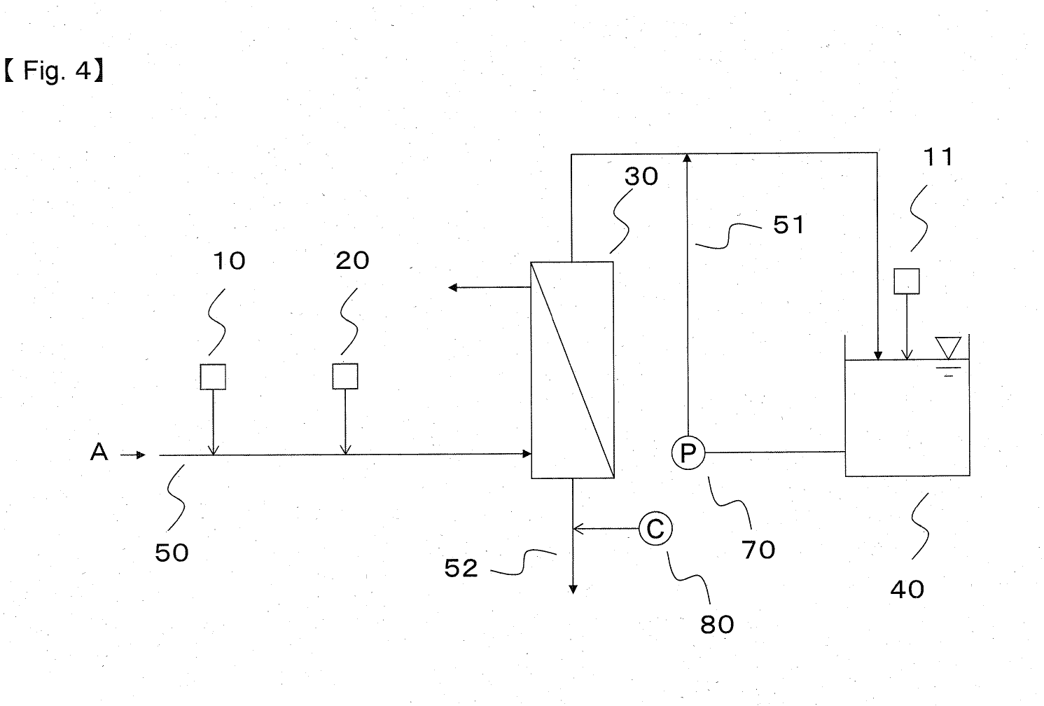

When the air scrubbing by introducing a gas on the primary side of the separation membrane module is simultaneously conducted in the first back washing substep and/or the second back washing substep of the step of back washing, the installation may have the constitution as shown in FIG. 4 provided with the compressed air introducing apparatus 80 wherein compressed air is supplied to the primary side of the separation membrane module 30. The compressed air introducing apparatus 80 is not particularly limited, and a blower, a compressor, or the like may be used for this apparatus. The installation having such constitution is preferable since such constitution enables the so called “simultaneous air scrubbing—back washing” wherein the buck wash of the separation membrane module 30 by the first cleaning water or the second cleaning water can be conducted simultaneously with the air scrubbing by the air supplied by the compressed air introducing apparatus 80. Compared to the case of the so called “sequential air scrubbing—back washing” wherein the air scrubbing is conducted by supplying the compressed air on the primary side of the separation membrane module after the first back washing substep and wherein the coagulation flocks and the like that had once been peeled off the separation membrane by the air scrubbing may again become attached to the separation membrane without being discharged to the exterior of the separation membrane module resulting in the loss of operativity, the “simultaneous air scrubbing—back washing” wherein the air scrubbing is conducted with the back washing is capable of preventing the re-attaching of the coagulation flocks and the like that had been once peeled off the separation membrane to the separation membrane and facilitating the discharging of the coagulation flocks and the like from the separation membrane module.

It is to be noted that, while the installation of FIG. 4 has the constitution that the compressed air introducing apparatus 80 is added to the installation of FIG. 1, the installations of FIGS. 2 and 3 may have the constitution that the compressed air introducing apparatus 80 is added at the similar position and air scrubbing is simultaneously conducted with the second back washing substep. This is preferable since similar effects are realized.

In the step of drainage, the cleaning drainage remaining on the primary side of the separation membrane module 30 is drained by the water drainage line 52. Alternatively, drained air scrubbing may be conducted after the back washing with the first cleaning water or the second cleaning water, by introducing the compressed air on the primary side of the separation membrane module 30 simultaneously with the lowering of the water surface on the primary side of the separation membrane module 30. Use of this method enables drainage while preventing re-attachment of the suspended substances and the coagulation flocks that had once been washed away from the separation membrane back to the separation membrane.

In the present invention, the method used for introducing the pH adjuster in the first pH adjustment apparatus 10 is not particularly limited, and the first pH adjuster at predetermined concentration may be introduced at a constant rate, or a pH meter may be provided in the downstream of the first pH adjustment apparatus 10 and the amount of the first pH adjuster introduced may be regulated depending on the indication of the pH meter. Preferably, the pH adjuster is introduced so that the predetermined pH is realized after the introduction of cationic coagulant. Since the pH decreases by the introduction of the coagulant, the pH meter may be provided in the downstream of the cationic coagulant introducing apparatus 20, and the amount of the first pH adjuster introduced may be regulated depending on the indication of the pH meter.

The method used for introducing the second pH adjuster when the cleaning water satisfying the expressions (ii) and (iii) is prepared by adding the second pH adjuster to the filtrated water in the first back washing substep of the step of back washing is not particularly limited. Exemplary methods include introduction in the filtrated water tank 40 with agitation; and introduction into the back wash cleaning water line 51 connecting the filtrated water tank 40 and the secondary side of the separation membrane module 30 followed by mixing using an inline mixer or mixing using the back wash pump 70, and if desired, a pH meter may be provided in the downstream of the introduction point, and the amount of the pH adjuster introduced may be regulated depending on the indication of the pH meter.

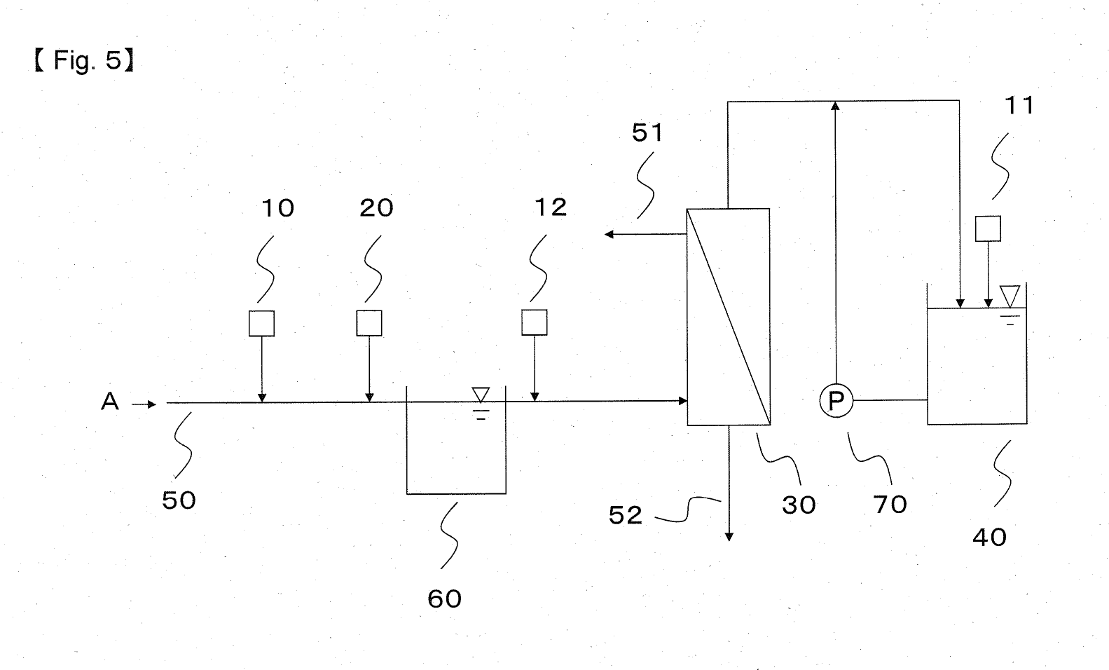

Next, in FIG. 5, the liquid separated from the pretreated water in a liquid-solid separating apparatus 60 is used for the water to be filtrated, and this water is filtrated through the separation membrane module 30. The method used for the separation of the liquid and the solid is not particularly limited although separation by precipitation is the common method, and methods such as sand filtration and membrane separation may also be used as long as the method is capable of removing the coagulation flocks.

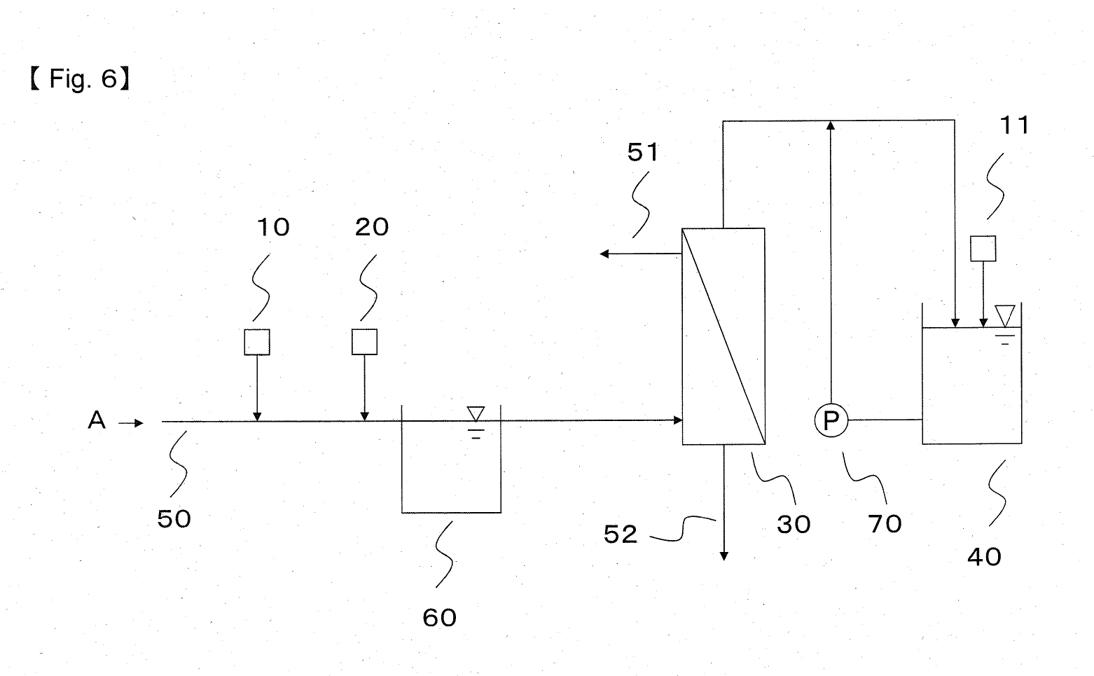

In FIG. 6, a third pH adjustment apparatus 12 is provided in the downstream of the liquid-solid separating apparatus 60. Such provision enables introduction of a third pH adjuster to the separated liquid, namely, adjustment of the pH to the level higher than the pH of the pretreated water to enable further stabilization of the operation of the separation membrane module 30.

### EXAMPLES

### Example 1

The water production was conducted by using the apparatus shown in the flow chart of FIG. 1, and the water to be treated was sewage water which had undergone the secondary treatment. In the first pH adjustment apparatus 10, the pretreated water was adjusted to pH 5.0 by using sulfuric acid, and in the cationic coagulant introducing apparatus 20, polyaluminum chloride (hereinafter referred to as PAC) was used for the cationic coagulant and PAC was added to the water supply line 50 so that PAC concentration in the pretreated water was 50 mg/L. PAC was mixed by using a line mixer. The pretreated water (the water to be filtrated) was filtrated through a membrane in the separation membrane module 30, and the filtrated water was stored in the filtrated water tank 40 that had been provided in the downstream of the separation membrane module 30. The filtrated water tank 40 had a second pH adjustment apparatus 11, and caustic soda was introduced so that the filtrated water tank 40 was at pH 6.0. After thorough mixing by an agitator to prepare the cleaning water, back washing of the separation membrane module 30 was conducted by using this cleaning water.

The separation membrane used in the separation membrane module 30 was HFU-2008 manufactured by Toray Industries, Inc. which is a PVDF UF membrane having a nominal pore diameter of 0.01 μm. The module was operated at a flux of 2 m/d, and the operation was conducted by the cycle of 30 minutes of the step of filtration; step of back washing (sequential air scrubbing—back washing) including 1 minute of the first back washing substep and 1 minute of the air scrubbing substep; 45 seconds of the step of drainage; and 45 seconds of water supplying to the separation membrane module after the step of drainage to restart the filtration cycle.

The intended component to be removed was virus, and the removal performance of the water production system was evaluated by the virus removal rate of 5.2 log or higher, which is the value used for water quality requirement of sewage recycle water in agricultural purposes. The virus model was MS2 which is a type of E. coli phage, and this virus was added to the water to be treated at 10⁵ to 10⁷ PFU/mL for the calculation of the removal rate. The MS2 concentration was measured by using the method described in ISO 10705-1:1997, and the virus removal rate was calculated by using equation (vii):

Removal rate=log{(MS2 concentration in the water to be treated)/(MS2 concentration in the filtrated water) (vii)

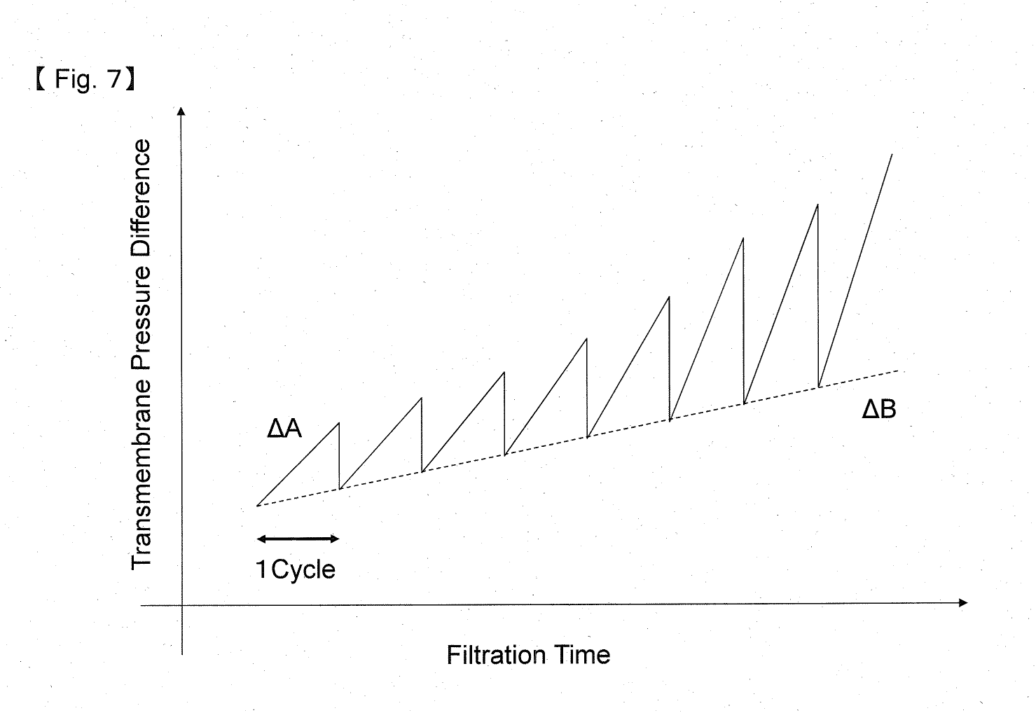

Continuous operation was conducted under the conditions as described above. ΔA value and increase rate calculable from the solid line shown in FIG. 7 and ΔB value calculable from dotted line shown in FIG. 7, pH in the interior of the separation membrane module after the step of water supplying, and removal rate of the component to be removed were measured, and the results are shown in Table 1.

It is to be noted that the solid line shown in FIG. 7 is the actual measurement of the transmembrane pressure difference at various timing, and the dotted line is the line obtained by approximation by least squares method in relation to the points recovered by the cleaning, ΔA shows increase rate of the transmembrane pressure difference (kPa/min) per cycle, and ΔB (kPa/d) shows increase rate of the transmembrane pressure difference at the points recovered by the cleaning. The operation is more stable when these values are smaller.

### Example 2

Continuous operation was conducted by using the conditions equivalent with the method described in Example 1 except that the pH of the cleaning water was adjusted to a pH of 7.0. The ΔA value and its increase rate and the ΔB value, the pH in the interior of the separation membrane module after the step of water supplying, the and removal rate of the component to be removed were measured, and the results are shown in Table 1.

### Example 3

Continuous operation was conducted by using the conditions equivalent with the method described in Example 1 except that the pH of the cleaning water was adjusted to a pH of 8.0. The ΔA value and its increase rate and the ΔB value, the pH in the interior of the separation membrane module after the step of water supplying, the and removal rate of the component to be removed were measured, and the results are shown in Table 1.

### Comparative Example 1

Continuous operation was conducted by using the conditions equivalent with the method described in Example 1 except that the pH of the cleaning water was adjusted to a pH of 5.0. The ΔA value and its increase rate and the ΔB value, the pH in the interior of the separation membrane module after the step of water supplying, the and removal rate of the component to be removed were measured, and the results are shown in Table 1.

### Comparative Example 2

Continuous operation was conducted by using the conditions equivalent with the method described in Example 1 except that the pH of the cleaning water was adjusted to a pH of 9.5. The ΔA value and its increase rate and the ΔB value, the pH in the interior of the separation membrane module after the step of water supplying, the and removal rate of the component to be removed were measured, and the results are shown in Table 1.

TABLE 1

| | Step of generating | | | | | | | |
|---|---|---|---|---|---|---|---|---|
| | water to be filtrated | Step of back washing | | ΔA | | | pH in the | |
| | Pretreated water | First | | | Increase | | module after | Virus |
| | (water to be filtrated) | cleaning | | Initial | rate | ΔB | supplying | removal |
| | pH | water pH | Operation | (kPa/min) | (kPa/min/d) | (kPa/d) | water | rate |
| Comparative | 5.0 | 5.0 | First back washing substep + | 0.6 | 8.2 | 13.3 | 5.0 | Realized |
| Example 1 | | | air scrubbing | | | | | |
| | | | (sequential air scrubbing − | | | | | |
| | | | back washing) | | | | | |
| Example 1 | 5.0 | 6.0 | First back washing substep + | 0.6 | 4.6 | 7.8 | 5.0 | Realized |
| | | | air scrubbing | | | | | |
| | | | (sequential air scrubbing − | | | | | |
| | | | back washing) | | | | | |
| Example 2 | 5.0 | 7.0 | First back washing substep + | 0.6 | 1.7 | 4.5 | 5.1 | Realized |
| | | | air scrubbing | | | | | |
| | | | (sequential air scrubbing − | | | | | |
| | | | back washing) | | | | | |
| Example 3 | 5.0 | 8.0 | First back washing substep + | 0.6 | 1.2 | 3.2 | 5.2 | Realized |
| | | | air scrubbing | | | | | |
| | | | (sequential air scrubbing − | | | | | |
| | | | back washing) | | | | | |
| Comparative | 5.0 | 9.5 | First back washing substep + | 0.6 | 0.7 | 2.4 | 5.4 | Temporarily |
| Example 2 | | | air scrubbing | | | | | not |
| | | | (sequential air scrubbing − | | | | | realized |
| | | | back washing) | | | | | |

As shown in Table 1, the increase of ΔA and the ΔB were high when the pH of the cleaning water was 5.0 whereas the increase of ΔA and the ΔB could be reduced by increasing the pH of the cleaning water to the level higher than the water to be filtrated. This tendency was more significant when the pH of the cleaning water was 6.0 or higher. In the meanwhile, the pH of the cleaning water of 9.0 or higher resulted in the tendency of temporary decrease in the removal rate of the component to be removed.

### Example 4

The water production was conducted by using the apparatus equivalent with the apparatus shown in the flow chart of FIG. 2, and the water to be treated was sewage water which had undergone the secondary treatment. In the first pH adjustment apparatus 10, the pretreated water was adjusted to pH 5.0 by using sulfuric acid, and in the cationic coagulant introducing apparatus 20, PAC was used for the cationic coagulant and PAC was added to the water supply line 50 so that PAC concentration in the pretreated water was 50 mg/L. PAC was mixed by using a line mixer. The pretreated water (the water to be filtrated) was filtrated through a membrane in the separation membrane module 30, and the filtrated water was stored in the filtrated water tank 40 that had been provided in the downstream of the separation membrane module. The second pH adjustment apparatus 11 was provided in the back wash cleaning water line 51, and the caustic soda was added so that the cleaning water was at a pH of 9.0. The agitation was conducted by using a line mixer.

The separation membrane used in the separation membrane module 30 was HFU-2008 manufactured by Toray Industries, Inc. which is a PVDF UF membrane having a nominal pore diameter of 0.01 μm. The module was operated at a flux of 2 m/d, and the operation was conducted by the cycle similar to that of Example 1 except that the step of back washing was conducted by 1 minute of first back washing substep using the first cleaning water and 1 minute of the second back washing substep using the filtrated water for the second cleaning water.

Achievement of the target removal rate was determined by the same method as the one described in Example 1.

Continuous operation was conducted under the conditions as described above. The ΔA value and increase rate calculable from the solid line shown in FIG. 7 and the ΔB value calculable from dotted line shown in FIG. 7, the pH in the interior of the separation membrane module after supplying the water, the removal rate of the component to be removed were measured, and the results are shown in Table 2.

### Example 5

Continuous operation was conducted by using the conditions equivalent with the method described in Example 6 except that drainage was conducted between the first back washing substep and the second back washing substep. The ΔA value and its increase rate and the ΔB value, the pH in the interior of the separation membrane module after the step of water supplying, the and removal rate of the component to be removed were measured, and the results are shown in Table 2.

TABLE 2

| | Step of generating | | | | | | | |
|---|---|---|---|---|---|---|---|---|
| | water to be filtrated | Step of back washing | | ΔA | | | pH in the | |
| | Pretreated water | First | | | Increase | | module after | Virus |
| | (water to be filtrated) | cleaning | | Initial | rate | ΔB | supplying | removal |
| | pH | water pH | Operation | (kPa/min) | (kPa/min/d) | (kPa/d) | water | rate |
| Example 3 | 5.0 | 8.0 | First back washing substep + | 0.6 | 1.2 | 3.2 | 5.2 | Realized |
| | | | air scrubbing | | | | | |
| | | | (sequential air scrubbing − | | | | | |
| | | | back washing) | | | | | |
| Example 4 | 5.0 | 9.0 | First back washing substep (pH 9) + | 0.6 | 0.7 | 1.7 | 5.1 | Realized |
| | | | second back washing substep (pH 5) + | | | | | |
| | | | air scrubbing | | | | | |
| | | | (sequential air scrubbing − | | | | | |
| | | | back washing) | | | | | |
| Example 5 | 5.0 | 9.0 | First back washing substep (pH 9) + | 0.6 | 0.7 | 1.7 | 5.0 | Realized |
| | | | draining + second back washing | | | | | |
| | | | substep (pH 5) + air scrubbing | | | | | |
| | | | (sequential air scrubbing − | | | | | |
| | | | back washing) | | | | | |

As shown in Table 2, by conducing the second back washing substep using the filtrated water not containing the second pH adjuster after the first back washing substep using the first cleaning water, increase in the pH in the interior of the separation membrane module after supplying the water could be suppressed and varying of the removal rate of the component to be removed could be avoided to the level further than the Example 3 wherein the second back washing substep was not conducted and the first back washing substep was conducted at pH 8. Furthermore, increase in the pH in the interior of the separation membrane module could be further suppressed by conducting the drainage between the first back washing substep and the second back washing substep.

### Example 6

The water production was conducted by using the apparatus equivalent with the apparatus shown in the flow chart of FIG. 4, and the water to be treated was sewage water which had undergone the secondary treatment. In the first pH adjustment apparatus 10, the pretreated water was adjusted to pH 5.0 by using sulfuric acid, and in the cationic coagulant introducing apparatus 20, PAC was used for the cationic coagulant and PAC was added to the water supply line 50 so that PAC concentration in the pretreated water was 50 mg/L. PAC was mixed by using a line mixer. The pretreated water (the water to be filtrated) was filtrated through a membrane in the separation membrane module 30, and the filtrated water was stored in the filtrated water tank 40 that had been provided in the downstream of the separation membrane module. The filtrated water tank 40 had a second pH adjustment apparatus 11, and caustic soda was introduced so that the filtrated water tank was at pH 8.0. By thoroughly mixing by an agitator, the first cleaning water was prepared. By using this first cleaning water, simultaneous back washing and air scrubbing was conducted as the first back washing substep by conducting back washing of the separation membrane module 30 simultaneously with the supplying of compressed air to the primary side of the separation membrane module 30 by a compressor provided on the water drainage line 52.

The separation membrane used in the separation membrane module 30 was HFU-2008 manufactured by Toray Industries, Inc. which is a PVDF UF membrane having a nominal pore diameter of 0.01 μm. The module was operated at a flux of 2 m/d, and the operation was conducted by the cycle of 30 minutes of the step of filtration; 1 minute of first back washing substep as the step of back washing (simultaneous air scrubbing—back washing); 45 seconds of step of drainage; and 45 seconds of water supplying to the separation membrane module after the step of drainage to restart the filtration cycle.

Achievement of the target removal rate was determined by the same method as the one described in Example 1.

Continuous operation was conducted under the conditions as described above. The ΔA value and its increase rate and the ΔB value shown in FIG. 7, the pH in the interior of the separation membrane module after the step of water supplying, and the removal rate of the component to be removed were measured, and the results are shown in Table 3.

TABLE 3

| | Step of generating | | | | | | | |
|---|---|---|---|---|---|---|---|---|
| | water to be filtrated | Step of back washing | | ΔA | | | pH in the | |
| | Pretreated water | First | | | Increase | | module after | Virus |
| | (water to be filtrated) | cleaning | | Initial | rate | ΔB | supplying | removal |
| | pH | water pH | Operation | (kPa/min) | (kPa/min/d) | (kPa/d) | water | rate |
| Example 3 | 5.0 | 8.0 | First back washing substep + | 0.6 | 1.2 | 3.2 | 5.2 | Realized |
| | | | air scrubbing | | | | | |
| | | | (sequential air scrubbing − | | | | | |
| | | | back washing) | | | | | |
| Example 6 | 5.0 | 8.0 | First back washing substep + | 0.6 | 0.3 | 1.5 | 5.2 | Realized |
| | | | air scrubbing | | | | | |
| | | | (simultaneous air scrubbing − | | | | | |
| | | | back washing) | | | | | |

As shown in Table 3, by conducting the simultaneous air scrubbing-back washing as the first back washing substep of the step of back washing, the increase of ΔA and the ΔB value could be reduced, and stability of the operation was thereby improved.

### Example 7

The water production was conducted by using the apparatus equivalent with the apparatus shown in the flow chart of FIG. 5, and the water to be treated was sewage water which had undergone the secondary treatment. In the first pH adjustment apparatus 10, the pretreated water was adjusted to pH 5.0 by using sulfuric acid, and in the cationic coagulant introducing apparatus 20, PAC was used for the cationic coagulant and PAC was added to the water supply line 50 so that PAC concentration in the pretreated water was 50 mg/L. PAC was mixed by using a line mixer. The pretreated water was separated by precipitation in the liquid-solid separating apparatus 60, and the precipitation supernatant (separated liquid) was used as the water to be filtrated. The water to be filtrated was filtrated through a membrane in the separation membrane module 30, and the filtrated water was stored in the filtrated water tank 40 that had been provided in the downstream of the separation membrane module. The filtrated water tank 40 had a second pH adjustment apparatus 11, and caustic soda was introduced so that the filtrated water tank 40 was at pH 8.0. By thoroughly mixing by an agitator, the first cleaning water was prepared. By using this first cleaning water, back washing of the separation membrane module 30 was conducted. After the back washing, air scrubbing was conducted by supplying compressed air to the primary side of the separation membrane module by a compressor provided on the water drainage line 52, and then, the water on the primary side of the separation membrane module was drained.

The separation membrane used in the separation membrane module 30 was HFU-2008 manufactured by Toray Industries, Inc. which is a PVDF UF membrane having a nominal pore diameter of 0.01 μm. The module was operated at a flux of 2 m/d, and the operation was conducted by the cycle of 30 minutes of the step of filtration; 1 minute of first back washing substep as the step of back washing and 1 minute of air scrubbing (sequential air scrubbing—back washing); 45 seconds of step of drainage (air wash drainage); and 45 seconds of water supplying to the separation membrane module after the drainage step to restart the filtration cycle.

Achievement of the target removal rate was determined by the same method as the one described in Example 1.

Continuous operation was conducted under the conditions as described above. The ΔA value and the increase rate and the ΔB value shown in FIG. 7, the pH in the interior of the separation membrane module after the step of water supplying, and the removal rate of the component to be removed were measured, and the results are shown in Table 4.

### Example 8

The water production was conducted by using the apparatus equivalent with the apparatus shown in the flow chart of FIG. 6, and the water to be treated was sewage water which had undergone the secondary treatment. In FIG. 6, caustic soda was introduced from the third pH adjustment apparatus 12 to adjust pH of the precipitation supernatant to 6.0. Otherwise, continuous operation was conducted under the conditions equivalent to those described for Example 7, and ΔA value and its increase rate and the ΔB value, the pH in the interior of the separation membrane module after the step of water supplying, and the removal rate of the component to be removed were measured, and the results are shown in Table 4.

### Example 9

Continuous operation was conducted by using the conditions equivalent with the method described in Example 8 except that the pH of the precipitation supernatant was adjusted to a pH of 7.0. The ΔA value and its increase rate and the ΔB value, the pH in the interior of the separation membrane module after the step of water supplying, the and removal rate of the component to be removed were measured, and the results are shown in Table 4.

### Comparative Example 3

Continuous operation was conducted by using the conditions equivalent with the method described in Example 8 except that the pH of the precipitation supernatant was adjusted to a pH of 8.0. The ΔA value and its increase rate and the ΔB value, the pH in the interior of the separation membrane module after the step of water supplying, and the removal rate of the component to be removed were measured, and the results are shown in Table 4.

TABLE 4

| | Step of generating water to be filtrated | | | Step of back washing | | ΔA | | | | |
|---|---|---|---|---|---|---|---|---|---|---|
| | Coagulation | Solid-liquid | | First | | | Increase | | pH in the | |
| | substep | separation substep | | cleaning | | Initial | rate | ΔB | module after | Virus |
| | Pretreated | Yes/ | Separated | water | | (kPa/ | (kPa/ | (kPa/ | supplying | removal |
| | water pH | NO | liquid pH | pH | Operation | min) | min/d) | d) | water | rate |
| Example 3 | 5.0 | No | — | 8.0 | First back washing substep + | 0.6 | 1.2 | 3.2 | 5.2 | Realized |
| | (Water | | | | air scrubbing | | | | | |
| | to be | | | | (sequential air scrubbing − | | | | | |
| | filtrated) | | | | back washing) | | | | | |
| Example 7 | 5.0 | Yes | 5.0 | 8.0 | First back washing substep + | 0.2 | 0.2 | 0.6 | 5.2 | Realized |
| | | | (Water | | air scrubbing | | | | | |
| | | | to be | | (sequential air scrubbing − | | | | | |
| | | | filtrated) | | back washing) | | | | | |
| Example 8 | 5.0 | Yes | 6.0 | 8.0 | First back washing substep + | 0.2 | 0.1 | 0.5 | 6.1 | Realized |
| | | | (Water | | air scrubbing | | | | | |
| | | | to be | | (sequential air scrubbing − | | | | | |
| | | | filtrated) | | back washing) | | | | | |
| Example 9 | 5.0 | Yes | 7.0 | 8.0 | First back washing substep + | 0.2 | 0.1 | 0.5 | 7.0 | Realized |
| | | | (Water | | air scrubbing | | | | | |
| | | | to be | | (sequential air scrubbing − | | | | | |
| | | | filtrated) | | back washing) | | | | | |
| Comparative | 5.0 | Yes | 8.0 | 8.0 | First back washing substep + | 0.2 | 0.1 | 0.4 | 8.0 | Not |
| Example 3 | | | (Water | | air scrubbing | | | | | realized |
| | | | to be | | (sequential air scrubbing − | | | | | |
| | | | filtrated) | | back washing) | | | | | |

As shown in Table 4, operation performance could be greatly improved without sacrificing the virus removal rate by conducting the separation of the pretreated water by precipitation. The operation performance could be further improved without sacrificing the virus removal rate by adequately regulating the pH of the separated liquid. In the meanwhile, excessively increased pH resulted in the reduced virus removal rate, and the target removal rate could not be realized.

The present invention can be used in water purification plant and sewage and waste water treatment plant wherein river water or sewage water is treated by using a separation membrane module. The present invention can be used in water purification plant and sewage and waste water treatment plant wherein coagulation treatment is used in the substep before the separation membrane module.

### EXPLANATION OF NUMERALS

A: water to be treated
10: first pH adjustment apparatus
11: second pH adjustment apparatus
12: third pH adjustment apparatus
20: cationic coagulant introducing apparatus
30: separation membrane module
40: filtrated water tank
41: pH adjustment tank
50: water supply line
51: back wash cleaning water line
52: water drainage line
60: liquid-solid separating apparatus
70: back wash pump
80: compressed air introducing apparatus

1. A process for producing water comprising:
a step of generating a water to be filtrated wherein a water to be treated is treated to generate a water to be filtrated;
a step of filtration wherein the water to be filtrated is filtrated through a separation membrane module having a separation membrane to generate a filtrated water;
a step of back washing wherein a substance to be removed by filtration which has blocked the separation membrane in the step of filtration is washed away by using a cleaning water; and
a step of drainage wherein cleaning drainage generated in the step of back washing is drained; wherein
the step of generating the water to be filtrated has a coagulation substep of adding a first pH adjuster and a cationic coagulant to coagulate the substance to be removed by filtration in the water to be treated to thereby generate the pretreated water;
the water to be filtrated used in the step of filtration satisfies the following expression (i); and
the step of back washing has at least first back washing substep wherein the separation membrane is back-washed by the cleaning water satisfying the following expressions (ii) and (iii):
4.0≦pH of the water to be filtrated≦6.5 (i)
pH of the cleaning water≦9.0 (ii)
pH of the cleaning water−pH of the water to be filtrated≧1.0 (iii).

2. The process for producing water according to claim 1 wherein, in the first back washing substep of the step of back washing, a second pH adjuster is added to the filtrated water to prepare the cleaning water satisfying the expressions (ii) and (iii).

3. The process for producing water according to claim 1 wherein second back washing substep wherein further back wash is conducted by using the filtrated water is conducted after the first back washing substep of the step of back washing.

4. The process for producing water according to claim 1 wherein, in the first back washing substep of the step of back washing, air scrubbing by introducing a gas on the primary side of the separation membrane module is simultaneously conducted.

5. The process for producing water according to claim 3 wherein, in the second back washing substep of the step of back washing, air scrubbing by introducing a gas on the primary side of the separation membrane module is simultaneously conducted.

6. The process for producing water according to claim 1 wherein the step of generating the water to be filtrated has a solid-liquid separation substep for obtaining a separated liquid after the coagulation substep.

7. The process for generating water according to claim 6 wherein the pH adjuster is introduced in the separated liquid and the pH is adjusted in each step and/or substep to satisfy the following expression (iv) to (vi):
pH of the pretreated water≦pH of the water to be filtrated≦pH of the cleaning water (iv)
pH of the water to be filtrated−pH of the pretreated water≧1.0 (v)
pH of the water to be filtrated≦7.5 (vi).
